(19) United States
(12) Patent Application Publication
(10) Pub. No.: US 2024/0187162 A1
(43) Pub. Date: Jun. 6, 2024

(54) SYSTEMS AND METHODS FOR HANDLING LIMITED SET OF PATH LOSS REFERENCE SIGNALS

(71) Applicant: Telefonaktiebolaget LM Ericsson (publ), Stockholm (SE)

(72) Inventors: Andreas Nilsson, Göteborg (SE); Siva Muruganathan, Stittsville (CA); Claes Tidestav, Bålsta (SE); Jianwei Zhang, Solna (SE)

(21) Appl. No.: 18/285,331

(22) PCT Filed: Apr. 6, 2022
(86) PCT No.: PCT/EP2022/059060

§ 371 Date: Oct. 2, 2023

Related U.S. Application Data
(60) Provisional application No. 63/171,363, filed on Apr. 6, 2021.

(51) Int. Cl. H04L 5/00

(52) U.S. Cl. CPC H04L 5/0048; H04L 5/0091

(57) ABSTRACT

Systems and methods are disclosed for handling a limited set of Path Loss Reference Signals (PL-RSs). In one embodiment, a method performed by a wireless communication device comprises determining a subset of a set of activated uplink (UL) transmission configuration indicator (TCI) states or activated joint or downlink (DL) TCI states for the wireless communication device for which the wireless communication device is to monitor associated pathloss reference signals. The method further comprises monitoring the pathloss reference signals for the subset of the set of activated UL TCI states or activated joint or DL TCI states. In this manner, the wireless communication device is enabled to have a well-defined framework for how to handle uplink output power when the network indicates a switch to a new UL state or new joint or DL TCI state for which the UE is not monitoring a pathloss reference signal.

### RELATED APPLICATIONS

This application claims the benefit of provisional patent application Ser. No. 63/171,363, filed Apr. 6, 2021, the disclosure of which is hereby incorporated herein by reference in its entirety.

### TECHNICAL FIELD

The present disclosure relates to a cellular communications system and, more specifically, to handling of pathloss reference signals (PT-RSs) in a cellular communications system.

### BACKGROUND

### 1 New Radio (NR)

The new generation mobile wireless communication system (5G) or new radio (NR) supports a diverse set of use cases and a diverse set of deployment scenarios. NR uses Cyclic Prefix Orthogonal Frequency Division Multiplexing (CP-OFDM) in the downlink (i.e., from a network node, NR base station (gNB), evolved NodeB (eNB), or base station, to a user equipment (UE)) and both CP-OFDM and Discrete Fourier Transform (DFT) spread Orthogonal Frequency Division Multiplexing (OFDM) (aka DFT-S-OFDM) in the uplink (i.e., from UE to gNB). In the time domain, NR downlink and uplink physical resources are organized into equally-sized subframes of 1 millisecond (ms) each. A subframe is further divided into multiple slots of equal duration.

The slot length depends on subcarrier spacing. For subcarrier spacing of Δƒ=15, kilohertz (kHz), there is only one slot per subframe and each slot always consists of 14 OFDM symbols, irrespectively of the subcarrier spacing.

Typical data scheduling in NR is on a per slot basis. An example is shown in FIG. 1 where the first two symbols contain Physical Downlink Control Channel (PDCCH) and the remaining twelve symbols contain Physical Data Channel (PDCH), which may be either a Physical Downlink Shared Channel (PDSCH) or a Physical Uplink Shared Channel (PUSCH).

Different subcarrier spacing values are supported in NR. The supported subcarrier spacing values (also referred to as different numerologies) are given by Δƒ=(15×2^{α}) kHz where α is a non-negative integer. Δƒ=15 kHz is the basic subcarrier spacing that is also used in Long Term Evolution (LTE). The slot durations at different subcarrier spacings are shown in Table 1.

TABLE 1
Slot length at different numerologies.

| | | |
|---|---|---|
| Numerology | Slot length | RB BW |

| | | | | |
|---|---|---|---|---|
| 15 kHz | 1 | ms | 180 | kHz |
| 30 kHz | 0.5 | ms | 360 | kHz |
| 60 kHz | 0.25 | ms | 720 | kHz |
| 120 kHz | 125 | ms | 1.44 | MHz |
| 240 kHz | 62.5 | ms | 2.88 | MHz |

In the frequency domain physical resource definition, a system bandwidth is divided into resource blocks (RBs), each corresponds to twelve contiguous subcarriers. The common RBs (CRBs) are numbered starting with 0 from one end of the system bandwidth. The UE is configured with one or up to four bandwidth parts (BWPs), which may be a subset of the RBs supported on a carrier. Hence, a BWP may start at a CRB larger than zero. All configured BWPs have a common reference, which is CRB 0. Hence, a UE can be configured with a narrow BWP (e.g., 10 Megahertz (MHZ)) and a wide BWP (e.g., 100 MHZ), but only one BWP can be active for the UE at a given point in time. The physical RBs (PRBs) are numbered from 0 to N-1 within a BWP, but the 0:th PRB may thus be the K:th CRB where K>0.

The basic NR physical time-frequency resource grid is illustrated in FIG. 2, where only one RB within a 14-symbol slot is shown. One OFDM subcarrier during one OFDM symbol interval forms one Resource Element (RE).

Downlink transmissions can be dynamically scheduled, i.e., in each slot the gNB transmits Downlink Control Information (DCI) over PDCCH about which UE data is to be transmitted to and which RBs in the current downlink slot the data is transmitted on. PDCCH is typically transmitted in the first one or two OFDM symbols in each slot in NR. The UE data are carried on PDSCH. A UE first detects and decodes PDCCH and, if the decoding is successful, it then decodes the corresponding PDSCH based on the decoded control information in the PDCCH.

Uplink data transmission can also be dynamically scheduled using PDCCH. Similar to downlink, a UE first decodes uplink grants in PDCCH and then transmits data over PUSCH based the decoded control information in the uplink grant such as modulation order, coding rate, uplink resource allocation, etc.

### 2 QCL and TCI States

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving signal on the other antenna port.

For example, there may be a QCL relation between a Channel State Information Reference Signal (CSI-RS) for tracking RS (TRS) and the PDSCH Demodulation Reference Signal (DMRS). When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its receive (RX) beam in some direction prior to receiving a certain signal. If the UE knows that the signal is spatially QCL with some other signal it has received earlier, then it can safely use the same RX beam to receive also this signal. Note that for beam management, the discussion mostly revolves around QCL Type D, but it is also necessary to convey a Type A QCL relation for the RSs to the UE, so that it can estimate all the relevant large-scale parameters.

Typically, this is achieved by configuring the UE with a CSI-RS for tracking (TRS) for time/frequency offset estimation. To be able to use any QCL reference, the UE would have to receive it with a sufficiently good Signal to Interference plus Noise Ratio (SINR). In many cases, this means that the TRS must be transmitted in a suitable beam to a certain UE.

To introduce dynamics in beam and Transmission/Reception Point (TRP) selection, the UE can be configured through Radio Resource Control (RRC) signaling with up to 128 Transmission Configuration Indicator (TCI) states. The TCI state information element (Extracted from 3GPP TS 38.331) is shown in FIG. 3.

Each TCI state contains QCL information related to one or two RSs. For example, a TCI state may contain CSI-RS1 associated with QCL Type A and CSI-RS2 associated with QCL TypeD. If a third RS, e.g. the PDCCH DMRS, has this TCI state as QCL source, it means that the UE can derive Doppler shift, Doppler spread, average delay, delay spread from CSI-RS1 and Spatial Rx parameter (i.e., the RX beam to use) from CSI-RS2 when performing the channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates, via a Medium Access Control (MAC) Control Element (CE), one TCI state for PDCCH (i.e., provides a TCI for PDCCH) and up to eight TCI states for PDSCH. The number of active TCI states the UE support is a UE capability, but the maximum is eight.

Assume a UE has four activated TCI states from a list of 64 configured TCI states in total. Hence, sixty TCI states are inactive for this particular UE, and the UE needs not be prepared to have large scale parameters estimated for those inactive TCI states. But, the UE continuously tracks and updates the large-scale parameters for the RSs in the four active TCI states. When scheduling a PDSCH to a UE, the DCI contains a pointer to one activated TCI state. The UE then knows which large-scale parameter estimates to use when performing PDSCH DMRS channel estimation and thus PDSCH demodulation.

As long as the UE can use any of the currently activated TCI states, it is sufficient to use DCI signaling. However, at some point in time, none of the RSs in the currently activated TCI states can be received by the UE, i.e., when the UE moves out of the beams in which the RSs in the activated TCI states are transmitted. When this happens (or actually before this happens), the gNB would have to activate new TCI states. Typically, since the number of activated TCI states is fixed, the gNB would also have to deactivate one or more of the currently activated TCI states.

The two-step procedure related to TCI state update is depicted in FIG. 4.

### 3 TCI States Activation/Deactivation for UE-Specific PDSCH via MAC CE

Now we provide the details of the MAC CE signaling that is used to activate/deactivate TCI states for UE specific PDSCH. The structure of the MAC CE for activating/deactivating TCI states for UE specific PDSCH is given in FIG. 5. As shown in FIG. 5, the MAC CE contains the following fields:
Serving Cell ID: This field indicates the identity of the Serving Cell for which the MAC CE applies. The length of the field is 5 bits;
BWP ID: This field contains the ID corresponding to a downlink bandwidth part for which the MAC CE applies. The BWP ID is given by the higher layer parameter BWP-Id as specified in 3GPP TS 38.331. The length of the BWP ID field is 2 bits since a UE can be configured with up to 4 BWPs for DL;
A variable number of fields Tᵢ: If the UE is configured with a TCI state with TCI State ID i, then then the field Tᵢ indicates the activation/deactivation status of the TCI state with TCI State ID i. If the UE is not configured with a TCI state with TCI State ID i, the MAC entity shall ignore the Tᵢ field. The Tᵢ field is set to “1” to indicate that the TCI state with TCI State ID i shall be activated and mapped to the codepoint of the DCI Transmission Configuration Indication field, as specified in 3GPP TS 38.214. The Tᵢ field is set to “0” to indicate that the TCI state with TCI State ID i shall be deactivated and is not mapped to the codepoint of the DCI Transmission Configuration Indication field. It should be noted that the codepoint to which the TCI State is mapped is determined by the ordinal position among all the TCI States with Tᵢ field set to “1”. That is the first TCI State with Tᵢ field set to “1” shall be mapped to the codepoint value 0 of DCI Transmission Configuration Indication field, the second TCI State with Tᵢ field set to “1” shall be mapped to the codepoint value 1 of DCI Transmission Configuration Indication field, and so on. In NR Rel-15, the maximum number of activated TCI states is 8;
A Reserved bit R: this bit is set to ‘0’ in NR Rel-15.

Note that the TCI States Activation/Deactivation for UE-specific PDSCH MAC CE is identified by a MAC Protocol Data Unit (PDU) subheader with logical channel ID (LCID) as specified in Table 6.2.1-1 of 3GPP TS 38.321 (this table is reproduced herein as FIG. 5). The MAC CE for Activation/Deactivation of TCI States for UE-specific PDSCH has variable size.

### 4 TCI State Indication for UE-Specific PDSCH via DCI

The gNB can use DCI format 1_1 or 1_2 to indicate to the UE that it shall use one of the activated TCI states for the subsequent PDSCH reception. The field being used in the DCI is Transmission configuration indication, which is 3 bits if tci-PresentInDCI is “enabled” or tci-PresentForDCI-Format1-2-r16 is present respectively for DCI format 1_1 and DCI 1_2 by higher layer. One example of such a DCI indication is depicted in FIG. 6.

DCI code point 0 indicates the first TCI state index in the list of TCI states, DCI code point 1 indicates the second TCI state index in the list, and so on.

### 5 Uplink Power Control in NR

Uplink power control is used to determine a proper transmit power for PUSCH, PUCCH, and Sounding Reference Signal (SRS) to ensure that they are received by the gNB at an appropriate power level. The transmit power will depend on the amount of channel attenuation, the noise and interference level at the gNB receiver, and the data rate in case of PUSCH or PUCCH.

The uplink power control in NR consists of two parts, i.e., open-loop power control and closed-loop power control. Open-loop power control is used to set the uplink transmit power based on the pathloss estimation and some other factors including the target receive power, channel/signal bandwidth, modulation and coding scheme (MCS), fractional power control factor, etc.

Closed-loop power control is based on explicit power control commands received from the gNB. The power control commands are typically determined based on some UL measurements at the gNB on the actual received power. The power control commands may contain the difference between the actual and the target received powers. Either cumulative or non-cumulative closed-loop power adjustments are supported in NR. Up to two closed loops can be configured in NR for each UL channel or signal. A closed loop adjustment at a given time is also referred as a power control adjustment state.

With multi-beam transmission in frequency range 2 (FR2), pathloss estimation needs to also reflect the beamforming gains corresponding to an uplink transmit and receive beam pair used for the UL channel or signal. This is achieved by estimating the pathloss based on measurements on a downlink RS transmitted over the corresponding downlink beam pair. The DL RS is referred to as a DL pathloss RS. A DL pathloss RS can be a CSI-RS or SSB. For example, when a UL signal is transmitted in beam #1, CSI-RS#1 may be configured as the pathloss RS. Similarly, if a UL signal is transmitted in beam #2, CSI-RS#2 may be configured as the pathloss RS.

For a UL channel or signal (e.g., PUSCH, PUCCH, or SRS) to be transmitted in a UL beam pair associated with a pathloss RS with index n, its transmit power in a transmission occasion i within a slot in a bandwidth part (BWP) of a carrier frequency of a serving cell and a closed-loop index l (l=0,1) can be expressed as

$$P ( i , k , l ) = min \{ \begin{matrix}{P}_{CMAX} ( i ) \\ {P}_{open - loop} ( i , k ) + {P}_{closed - loop} ( i , l )\end{matrix}$$

where P_{CMAX}(i) is the configured UE maximum output power for the carrier frequency of the serving cell in transmission occasion i for the UL channel or signal. Pₒₚₑₙ₋ₗₒₒₚ(i, k) is the open loop power adjustment given below,

Pₒₚₑₙ₋ₗₒₒₚ(i,k)=P_{O}+P_{RB}(i)+αPL(k)+Δ(i)

where P_{O} is the nominal target receive power for the UL channel or signal, P_{RB}(i) is a power adjustment related to the number of RBs occupied by the channel or signal, PL is the pathloss estimation based on a pathloss reference signal, α is fractional pathloss compensation factor, and Δ(i) is a power adjustment related to MCS. P_{closed-loop}(i, l) is given below:

$${P}_{closed - loop} ( i , l ) = \{ \begin{matrix}{P}_{closed - loop} ( i - {i}_{0} , l ) + {{\sum }_{m = 0}}^{M} δ ( m , l ) ; if accumulation is enabled \\ δ ( i , l ) ; if accumulation is disabled ( i . e . , absolute is enable )\end{matrix}$$

where δ(i, l) is a transmit power control (TPC) command value included in a DCI format associated with the UL channel or signal at transmission occasion i and closed-loop l; Σₘ₌₀^{M}δ(m, l) is a sum of TPC command values that the UE receives for the channel or signal and the associated closed-loop l since the TPC command for transmission occasion i−i₀.

Note that power control parameters P_{O}, P_{RB}(i), α, PL, Δ(i), δ(i, l) are generally configured separately for each UL channel or signal (e.g., PUSCH, PUCCH, and SRS) and may be different for different UL channels or signals.

### 5.1 Power Control for SRS

For SRS, a pathloss RS and other power control parameters (e.g., P_{O}, α, etc.) are configured for each SRS resource set. Note that for each BWP in a serving cell, there can only be one SRS resource set configured with usage set to either “codebook” or “non-codebook” in NR.

For SRS closed-loop power control, a UE can have a dedicated closed loop for SRS or share the closed loop(s) of PUSCH in the same serving cell. This is configured by a higher layer parameter srs-PowerControlAdjustmentStates in each SRS resource set to select one out of three options, i.e., use the dedicated closed loop, the first closed loop for PUSCH, or the second closed loop for PUSCH. In case that the closed loop(s) are shared with PUSCH, P_{closed-loop}(i, l) for PUSCH applies to SRS transmitted in the SRS resource set.

For the dedicated loop configured for SRS, δ(m, l) corresponds to TPC command received in a PDCCH with DCI format 2_3 for the UE. The mapping between the 2 bits TPC command field in DCI and power adjustment values in dB are shown in Table 2.

### Default Pathloss RS:

If pathloss RS is not configured in an SRS resource set, and SRS_SpatialRelationInfo is not configured in an SRS resource, but the UE is configured with enableDefaultBeamPIForSRS, then the pathloss RS is a periodic RS resource with ‘QCL-TypeD’ in the TCI state of a CORESET with the lowest index, if CORESETs are configured in the active DL BWP, or in the active PDSCH TCI state with lowest ID, if CORESETs are not configured in the active DL BWP

### 5.2 Power Control for PUSCH

For PUSCH, P_{O}=P_{O,nominal_PUSCH}+P_{O,UE_PUSCH}, where P_{O,nominal_PUSCH} is RRC configured and P_{O,UE_PUSCH} can be dynamically selected. For dynamically scheduled PUSCH, as illustrated in FIG. 7, a UE is configured by RRC with a list of SRI-PUSCH-PowerControl elements among which one is selected by the SRS Resource Indicator (SRI) field in DCI (e.g., DCI formats 0_0, 0_1, 0_2). Each SRI-PUSCH-PowerControl consists of a PUSCH pathloss RS, one of two closed-loops, and a set of P_{O,UE_PUSCH}, α. δ(i, l) is indicated in a 2-bit TPC command field of the same DCI, where the mapping between the field value and the dB value is shown in Table 2.

In addition to TPC command field in DCI scheduling a PUSCH, PUSCH power control for a group of UEs is also supported by DCI format 2_2 with CRC scrambled by TPC-PUSCH-RNTI, in which power adjustments for multiple UEs can be signaled simultaneously.

TABLE 2
Mapping of TPC Command Field in DCI formats 0_0,
0_1, 0_2, 2_2 for PUSCH or DCI format 2_3 for SRS
to absolute and accumulated values.

| TPC Command | | |
|---|---|---|
| Field | Accumulated δ(m, l) [dB] | Absolute δ (m, l) [dB] |
| 0 | −1 | −4 |
| 1 | 0 | −1 |
| 2 | 1 | 1 |
| 3 | 3 | 4 |

For PUSCH with configured grant, P_{O}, α and closed loop index are semi-statically configured by RRC. For CG with RRC configured pathloss RS, the RS is used for pathloss estimation, otherwise, the pathloss RS indicated in the DCI activating the CG PUSCH is used for pathloss estimation.

### Default Pathloss RS:

If the PUSCH transmission is scheduled by a DCI format 0_0, and if the UE is configured with PUCCH-SpatialRelationInfo for a PUCCH resource with a lowest index in the BWP of the serving cell, the UE uses the same pathloss RS resource for PUSCH as for a PUCCH transmission in the PUCCH resource with the lowest index.

If SRI field is not present in a DCI format 0_1 or DCI format 0_2 scheduling a PUSCH, or SRI-PUSCH-PowerControl is not provided to the UE, or a PUSCH scheduled by DCI format 0_0 and PUCCH-SpatialRelationInfo is not configured, the pathloss RS is the one contained in the PUSCH-PathlossReferenceRS-Id with the lowest index value.

If the PUSCH transmission is scheduled by a DCI format 0_0, and if the UE is not configured with PUCCH-SpatialRelationInfo for a PUCCH resource, and if the UE is configured with enableDefaultBeamPIForPUSCH0_0, the UE in the BWP of the serving cell, the pathloss RS is then a periodic RS resource with ‘QCL-TypeD’ in a TCI state or QCL assumption of a CORESET with the lowest index in the active DL BWP of the primary cell.

### 5.3 Power Control for PUCCH

For PUCCH, P_{O}=P_{O,nominal_PUSCH}+P_{O,UE_PUSCH}, and α=1, where P_{O,nominal_PUSCH} is RRC configured cell specific parameter and P_{O,UE_PUCCH} is a UE specific parameter and can vary among different PUCCH resources. A UE is configured with a list of up to 8 P_{O,UE_PUCCH} (each with a P0-PUCCH-Id) and a list of up to 8 pathloss RS (each with a pucch-PathlossReferenceRS-Id). For each PUCCH resource, a PUCCH spatial relation (i.e., PUCCH-SpatialRelationInfo) is activated in which a closed-loop index, a pathloss RS (from the corresponding list), and a P_{O,UE_PUCCH} (from the corresponding list) are configured.

For closed loop power adjustment for PUCCH, up to two control loops may be configured. Accumulation is always enabled. TPC command for PUCCH HARQ A/N can be received in one of DCI formats 1_0, 1_1 or 1_2 scheduling the corresponding PDSCH or in DCI format 2_2 when the DCI is scrambled with TPC-PUCCH-RNTI. The mapping between a TPC field value in DCI and a power correction value in dB is shown in Table 3.

TABLE 3
Mapping of TPC Command Field in DCI format 1_0
or DCI format 1_1 or DCI format 1_2 or DCI format
2_2 to accumulated δ(m, l) values for PUCCH

| TPC Command Field | Accumulated δ(m, l) [dB] |
|---|---|
| 0 | −1 |
| 1 | 0 |
| 2 | 1 |
| 3 | 3 |

### Default Pathloss RS:

If PUCCH spatial relation is not configured but a list of pathloss RS is configured for PUCCH, then the first pathloss RS in the list is used.

If both the list of pathloss RS and PUCCH-SpatialRelationInfo are not configured, but the UE is configured with enableDefaultBeamPIForPUCCH, then the pathloss RS is a periodic RS resource with ‘QCL-TypeD’ in the TCI state of a CORESET with the lowest index in the active DL BWP of the primary cell.

### 6 Rel-17 TCI State Framework

In 3GPP Rel-17, a new enhanced TCI state framework will be specified. In meeting RAN1#103-e, it was agreed that the new TCI state framework should include a three stage TCI state indication (in a similar way as was described above for PDSCH) for all or a subset of all DL and/or UL channels/signals. In the first stage, RRC is used to configure a pool of TCI states. In the second stage, one or more of the RRC configured TCI states are activated via MAC-CE signaling. Finally, in the third stage, DCI signaling is used to select one of the TCI states that was activated via MAC-CE. The TCI states used for DL and UL channels/signals can either be taken from the same pool of TCI states or from separate pools of TCI states (i.e., from separate DL TCI state and UL TCI state pools). It is also possible that two separate lists of activated TCI states are used, one for DL channels/signals and one for UL channels/signals.

Some agreements from the RAN1#103-e meeting are copied below:

### Agreement

On beam indication signaling medium to support joint or separate DL/UL beam indication in Rel.17 unified TCI framework:
Support L1-based beam indication using at least UE-specific (unicast) DCI to indicate joint or separate DL/UL beam indication from the active TCI states
   The existing DCI formats 1_1 and 1_2 are reused for beam indication
Support activation of one or more TCI states via MAC CE analogous to Rel.15/16:

### Agreement

On Rel-17 unified TCI framework, to accommodate the case of separate beam indication for UL and DL:
Utilize two separate TCI states, one for DL and one for UL.
For the separate DL TCI:
   The source reference signal(s) in M TCIs provide QCL information at least for UE-dedicated reception on PDSCH and for UE-dedicated reception on all or subset of CORESETs in a CC
For the separate UL TCI:
   The source reference signal(s) in N TCIs provide a reference for determining common UL TX spatial filter(s) at least for dynamic-grant/configured-grant based PUSCH, all or subset of dedicated PUCCH resources in a CC
   Optionally, this UL TX spatial filter can also apply to all SRS resources in resource set(s) configured for antenna switching/codebook-based/non-codebook-based UL transmissions
FFS: Whether the UL TCI state is taken from a common/same or separate TCI state pool from DL TCI state

### 7 Path Loss Reference Signals for Rel-17 TCI State Framework

In RAN1#104-e, an agreement (see below) was made that lists different alternatives of how to associate a path loss reference signal (PL-RS) with a TCI state used to determine the UL spatial transmit (TX) filter (e.g., a DL TCI state/Joint TCI state and/or UL TCI state). The purpose of the association between the TCI states and the PL-RS is that the network should be able to quickly and efficiently switch TCI states for UL signals/channels without any additional signaling for updating the PL-RS.

In order to enable a quick UL TX beam switch (e.g., by indicating a new Joint/DL/UL TCI state to the UE in DCI Format 1_1 or DCI Format 1_2) without a temporary degradation in UL performance due to sub-optimal UL output power for the new UL TX spatial filter, the UE should preferably already have monitored a PL-RS associated with the new DL/Joint/UL TCI state for a certain time, since in order to calculate a reliable UL output power, several filtered PL-RS measurements are typically needed.

However, as can be seen in the bold and underlined part in the agreement below, a UE might not be able to monitor as many PL-RSs as the number of activated DL/Joint/UL TCI states. Currently, the agreement is that 8 active TCI states will be supported in Rel-17 TCI state framework; however, in the current NR specification, only 4 PL-RS can be monitored (per serving cell).

In addition, it is possible that new/other DCI formats (e.g., DCI format 1_1 without data, or UL DCI formats) will also be used to update the TCI state for the UL spatial TX filter (in Rel-17 or later releases). In this case, it is possible that more bits are allocated in the DCI formats to update the UL TX spatial filter, meaning that the UE might have even more than eight active TCI states for UL TX spatial filter selection. In this case, there is an even larger risk that the UE will not be able to monitor a PL-RS for each activated TCI state used for UL TX spatial filter selection.

### Agreement

On Rel.17 unified TCI framework:
Select at least one of the following alternatives by RAN1# 104bis-e for path-loss measurement (PL-RS):
Alt1. PL-RS can be included in UL TCI state or (if applicable) joint TCI state.
   FFS: Whether it is always included or not. If not included, PL-RS is the periodic DL-RS used as a source RS for determining spatial TX filter or the PL RS used for the UL RS in UL or (if applicable) joint TCI state.
Alt2. PL-RS can be associated with (but not included in) UL TCI state or (if applicable) joint TCI state
   FFS: Exact association mechanism
   FFS: Whether it is always associated or not. If not associated, PL-RS is the periodic DL-RS used as a source RS for determining spatial TX filter or the PL RS used for the UL RS in UL or (if applicable) joint TCI state
Alt3. The periodic DL-RS used as a source RS for determining spatial TX filter can be used as PL-RS. In case the periodic DL-RS used as a source RS for determining spatial TX filter is not used as PL-RS, reuse Rel.16 procedure with the same signaling structure (MAC CE+SRI field in UL-related DCI) to indicate PL-RS for UL transmission with minimum enhancement (e.g. pertaining to the use for PUCCH, or using default PL-RS)
   PL-RS is not additionally configured in or associated to UL TCI state or (if applicable) joint TCI state
Alt4. UE calculates path-loss based on periodic DL RS configured as the source RS or a periodic QCL-Type-D/spatialRelationInfo source of the source RS in UL TCI state or (if applicable) joint TCI state
   FFS: Whether UE can calculate path-loss based on DL periodic RS for path-loss calculation for UL RS in the UL TCI
FFS: Application time of PL-RS
NOTE: As in Rel-16, a UE does not expect to simultaneously maintain more than four path-loss estimates per serving cell for all PUSCH/PUCCH/SRS transmissions
FFS: investigate the condition(s) agreed in Rel-17 and, if needed, study whether a UE can simultaneously maintain more than four path-loss estimates

### SUMMARY

Systems and methods are disclosed for handling a limited set of Path Loss Reference Signals (PL-RSs). In one embodiment, a method performed by a wireless communication device comprises determining a subset of a set of activated uplink (UL) transmission configuration indicator (TCI) states or activated joint or downlink (DL) TCI states for the wireless communication device for which the wireless communication device is to monitor associated pathloss reference signals. The method further comprises monitoring the pathloss reference signals for the subset of the set of activated UL TCI states or activated joint or DL TCI states. In this manner, the wireless communication device is enabled to have a well-defined framework for how to handle uplink output power when the network indicates a switch to a new UL state or new joint or DL TCI state for which the UE is not monitoring a pathloss reference signal.

In one embodiment, the method further comprises receiving, from a base station, information that indicates the set of activated UL TCI states or activated joint or DL TCI states. In one embodiment, the information that indicates the set of activated UL TCI states or activated joint or DL TCI states comprises UL TCI state indicators or joint or DL TCI state indicators.

In one embodiment, the set of activated UL TCI states or activated joint or DL TCI states consists of M activated UL TCI states or M activated joint or DL TCI states, and the subset of the set of activated UL TCI states or activated joint or DL TCI states consists of less than M activated UL TCI states or less than M activated joint or DL TCI states. In one embodiment, determining the subset of the set of activated UL TCI states or activated joint or DL TCI states for which the wireless communication device is to monitor associated pathloss reference signals comprises selecting the subset from the set of activated UL TCI states or activated joint or DL TCI states based on associations between the activated UL TCI states or activated joint or DL TCI states and their TCI field codepoints. In one embodiment, the subset is N-1 of the M activated UL TCI states or N-1 of the M activated joint or DL TCI states having the lowest TCI field codepoints, where a value of N corresponds to a maximum number of pathloss reference signals that the wireless communication device is configured or otherwise able to monitor. In one embodiment, the wireless communication device also monitors a pathloss reference signal associated to a currently applied UL TCI state or joint or downlink DL TCI state of the wireless communication device. In another embodiment, the subset is N of the M activated UL TCI states or N of the activated joint or DL TCI states having the lowest TCI field codepoints, where a value of N corresponds to a maximum number of pathloss reference signals that the wireless communication device is configured or otherwise able to monitor. In one embodiment, the subset comprises an activated UL TCI state or an activated joint or DL TCI state that corresponds to a currently applied UL TCI state or a current applied joint or DL TCI state of the wireless communication device. In another embodiment, the subset is N-1 of the M activated UL TCI states or N-1 of the M activated joint or DL TCI states having the highest TCI field codepoints, where a value of N corresponds to a maximum number of pathloss reference signals that the wireless communication device is configured or otherwise able to monitor. In one embodiment, the wireless communication device also monitors a pathloss reference signal associated to a currently applied UL TCI state or a currently applied joint or DL TCI state the wireless communication device. In another embodiment, the subset is N of the M activated UL TCI states or N of the M activated joint or DL TCI states having the highest TCI field codepoints, where a value of N corresponds to a maximum number of pathloss reference signals that the wireless communication device is configured or otherwise able to monitor. In one embodiment, the subset comprises an activated UL TCI state or an activated joint or DL TCI state that corresponds to a currently applied UL TCI state or a currently applied joint or DL TCI state of the wireless communication device.

In another embodiment, the subset is N-1 of the M activated UL TCI states or N-1 of the M activated joint or DL TCI states that were last activated, where a value of N corresponds to a maximum number of pathloss reference signals that the wireless communication device is configured or otherwise able to monitor. In one embodiment, the wireless communication device also monitors a pathloss reference signal associated to a currently applied UL TCI state or a currently applied joint DL TCI state of the wireless communication device. In another embodiment, the subset is N of the M activated UL TCI states or N of the M activated joint or DL TCI states that were last activated, where a value of N corresponds to a maximum number of pathloss reference signals that the wireless communication device is configured or otherwise able to monitor. In one embodiment, the subset comprises an activated UL TCI state or an activated joint or DL TCI state that corresponds to a currently applied UL TCI state or a currently applied joint or DL TCI state of the wireless communication device. In one embodiment, determining the subset of the set of activated UL TCI states or activated joint or DL TCI states for which the wireless communication device is to monitor associated pathloss reference signals comprises selecting between two or more activated UL TCI states or two or more activated joint or DL TCI states that were activated at the same time based on one or more criteria. In one embodiment, the one or more criteria comprise lowest or highest TCI field codepoint.

In one embodiment, the subset is N-1 of the M activated UL TCI states or N-1 of the M activated joint or DL TCI states that have been activated for a shortest amount of time, where a value of N corresponds to a maximum number of pathloss reference signals that the wireless communication device is configured or otherwise able to monitor. In one embodiment, the wireless communication device also monitors a pathloss reference signal associated to a currently applied UL TCI state or a currently applied joint or DL TCI of the wireless communication device.

In one embodiment, the subset is N of the M activated UL TCI states or N of the M activated joint or DL TCI states that have been activated for a shortest amount of time, where a value of N corresponds to a maximum number of pathloss reference signals that the wireless communication device is configured or otherwise able to monitor. In one embodiment, the subset comprises an activated UL TCI state or an activated joint or DL TCI state that corresponds to a currently applied UL TCI state or a currently applied joint or DL TCI state of the wireless communication device.

In one embodiment, the subset is N-1 of the M activated UL TCI states or N-1 of the M activated joint or DL TCI states having the lowest TCI state IDs, where a value of N corresponds to a maximum number of pathloss reference signals that the wireless communication device is configured or otherwise able to monitor. In one embodiment, the wireless communication device also monitors a pathloss reference signal associated to a currently applied UL TCI state or a currently applied joint or DL TCI state of the wireless communication device.

In one embodiment, the subset is N of the M activated UL TCI states or N of the M activated joint or DL TCI states having the lowest TCI state IDs, where a value of N corresponds to a maximum number of pathloss reference signals that the wireless communication device is configured or otherwise able to monitor. In one embodiment, the subset comprises an activated UL TCI state or an activated joint or DL TCI state that corresponds to a currently applied UL TCI state or a currently applied joint or DL TCI state of the wireless communication device.

In one embodiment, the subset is N-1 of the M activated UL TCI states or N-1 of the M activated joint or DL TCI states having the highest TCI state IDs, where a value of N corresponds to a maximum number of pathloss reference signals that the wireless communication device) is configured or otherwise able to monitor. In one embodiment, the wireless communication device also monitors a pathloss reference signal associated to a currently applied UL TCI state or a currently applied joint or DL TCI state of the wireless communication device.

In one embodiment, the subset is N of the M activated UL TCI states or N of the M activated joint or DL TCI states having the highest TCI state IDs, where a value of N corresponds to a maximum number of pathloss reference signals that the wireless communication device is configured or otherwise able to monitor. In one embodiment, the subset comprises an activated UL TCI state or an activated joint or DL TCI state that corresponds to a currently applied UL TCI state or a currently applied joint or DL TCI state of the wireless communication device.

In one embodiment, the method further comprises receiving, from a network node, an indication of the subset of the set of activated UL TCI states or activated joint or DL TCI states for which the wireless communication device is to monitor associated pathloss reference signals, wherein determining the subset of the set of activated UL TCI states or activated joint or DL TCI states for which the wireless communication device is to monitor associated pathloss reference signals comprises determining the subset from the set of activated UL TCI states or activated joint or DL TCI states based on the received indication. In one embodiment, receiving the indication comprises receiving the indication via Radio Resource Control (RRC) signaling, Medium Access Control (MAC) Control Element (CE), Downlink Control Information (DC), or any combination thereof.

In one embodiment, the method further comprises using results of the monitoring for one or more operational tasks.

In one embodiment, the method further comprises obtaining a pathloss estimate for at least one activated UL TCI state or at least one joint or DL TCI state from the subset based on results of monitoring the pathloss reference signal associated to the at least one activated UL TCI state or the at least one activated joint or DL TCI state. In one embodiment, the method further comprises using the obtained pathloss estimate.

In one embodiment, the method further comprises receiving downlink control information (DCI) from a network node, the DCI comprising a TCI field codepoint that maps to an activated UL TCI state or an activated joint or DL TCI state from among the set of activated UL TCI states or activated joint or DL TCI states for which the wireless communication device is not currently monitoring an associated pathloss reference signal. The method further comprises, responsive thereto, obtaining a pathloss estimate for the activated UL TCI state or the activated joint or DL TCI state indicated by the TCI field codepoint comprised in the DCI. In one embodiment, obtaining the pathloss estimate for the activated UL TCI state or activated joint or DL TCI state indicated by the TCI field codepoint comprised in the DCI comprises obtaining the pathloss estimate based on a last measurement stored at the wireless communication device for the associated pathloss reference signal. In one embodiment, obtaining the pathloss estimate for the activated UL TCI state or activated joint or DL TCI state indicated by the TCI field codepoint comprised in the DCI comprises obtaining the pathloss estimate based on: a last measurement stored at the wireless communication device for the associated pathloss reference signal; and an offset. In one embodiment, obtaining the pathloss estimate for the activated UL TCI state or activated joint or DL TCI state indicated by the TCI field codepoint comprised in the DCI comprises obtaining the pathloss estimate based on a pathloss estimate determined by the wireless communication device based on a default pathloss reference signal. In one embodiment, the default pathloss reference signal is explicitly or implicitly configured. In one embodiment, the default pathloss reference signal is: a pathloss reference signal associated with a TCI state of a Control Resource Set (CORESET) in which a PDCCH comprising the DCI and scheduling a respective uplink transmission is received; a PUSCH transmission associated with DCI 0_0; a PUSCH transmission associated with Msg3; or a semi-persistent PUCCH used for initial transmission.

Corresponding embodiments of a wireless communication device are also disclosed. In one embodiment, a wireless communication device is adapted to determine a subset of a set of activated UL TCI states or activated joint or DL TCI states for the wireless communication device for which the wireless communication device is to monitor associated pathloss reference signals. The wireless device is further adapted to monitor the pathloss reference signals for the subset of the set of activated UL TCI states or activated joint or DL TCI states.

In one embodiment, a wireless communication device comprises one or more transmitters, one or more receivers, and processing circuitry associated with the one or more transmitters and the one or more receivers, the processing circuitry configured to cause the wireless communication device to: determine a subset of a set of activated UL TCI states or activated joint or DL TCI states for the wireless communication device for which the wireless communication device is to monitor associated pathloss reference signals and monitor the pathloss reference signals for the subset of the set of activated UL TCI states or activated joint or DL TCI states.

Embodiments of a method performed by a network node are also disclosed. In one embodiment, a method performed by a network node comprises transmitting, to a wireless communication device, an indication of a subset of a set of activated UL TCI states or activated joint or DL TCI states for the wireless communication device for which the wireless communication device is to monitor associated pathloss reference signals.

Corresponding embodiments of a network node are also disclosed. In one embodiment, a network node is adapted to transmit, to a wireless communication device, an indication of a subset of a set of activated UL TCI states or activated joint or DL TCI states for the wireless communication device for which the wireless communication device is to monitor associated pathloss reference signals.

In one embodiment, a network node comprises processing circuitry configured to cause the network node to transmit, to a wireless communication device, an indication of a subset of a set of activated UL TCI states or activated joint or DL TCI states for the wireless communication device for which the wireless communication device is to monitor associated pathloss reference signals.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a typical slot in Third Generation Partnership Project (3GPP) New Radio (NR);

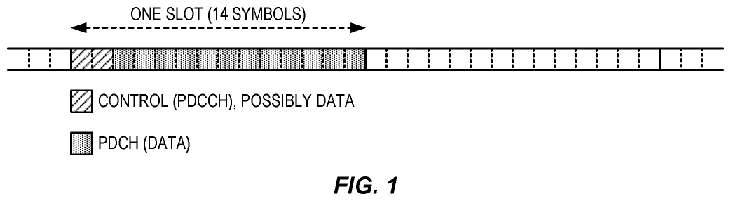

FIG. 2 illustrates the basic NR physical time-frequency resource grid;

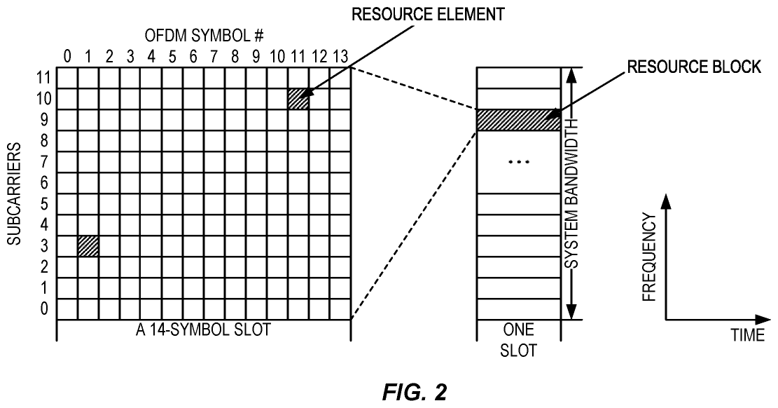

FIG. 3 illustrate the Transmission Configuration Indicator (TCI) state information element as defined in 3GPP Technical Specification (TS) 38.331;

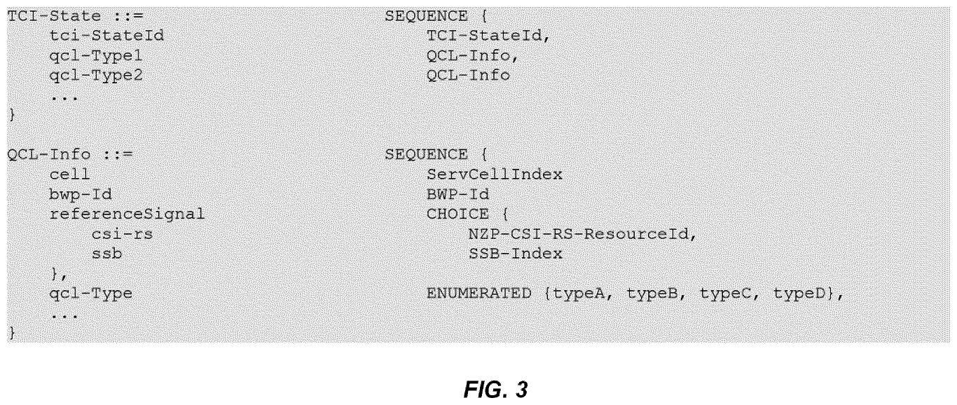

FIG. 4 illustrates the two-step procedure related to TCI state update;

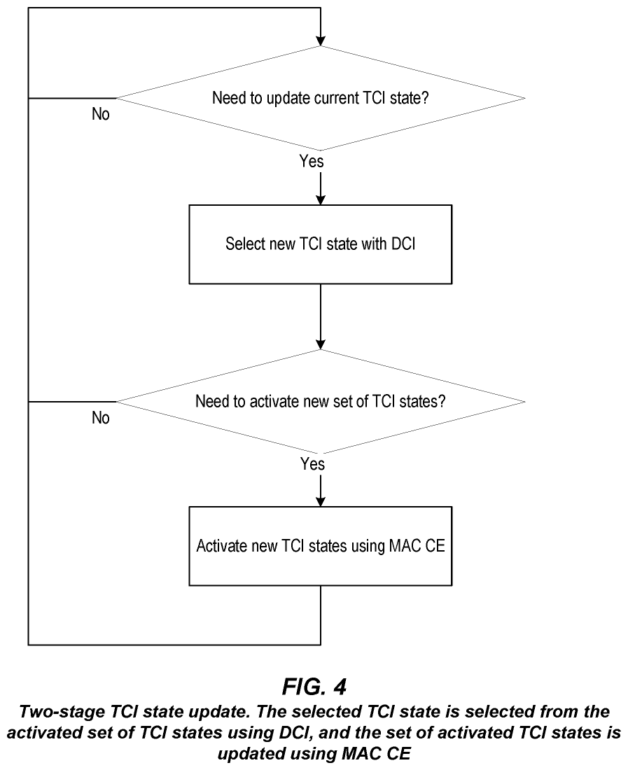

FIG. 5 illustrates the structure of the Medium Access Control (MAC) Control Element (CE) for activating/deactivating TCI states for User Equipment (UE) specific Physical Downlink Shared Channel (PDSCH);

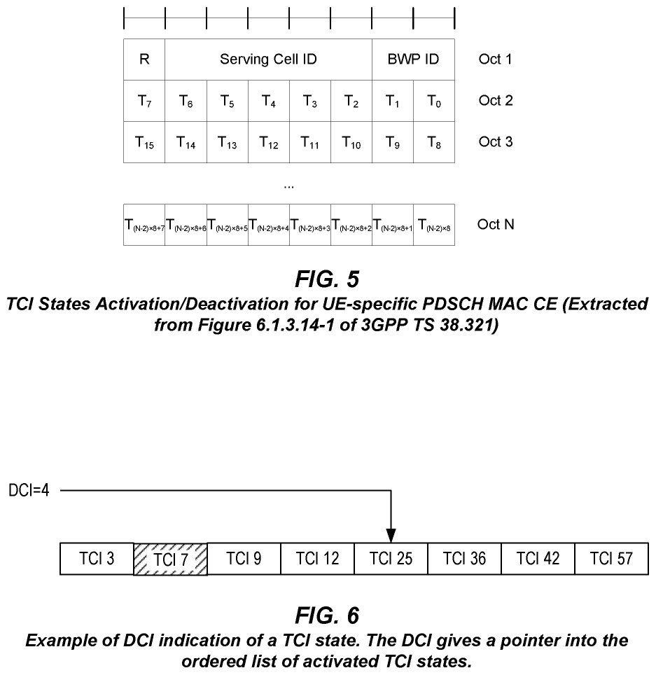

FIG. 6 illustrates one example of a Downlink Control Information (DCI) indication to a UE that the UE is to use one of the activated TCI states for a subsequent PDSCH reception;

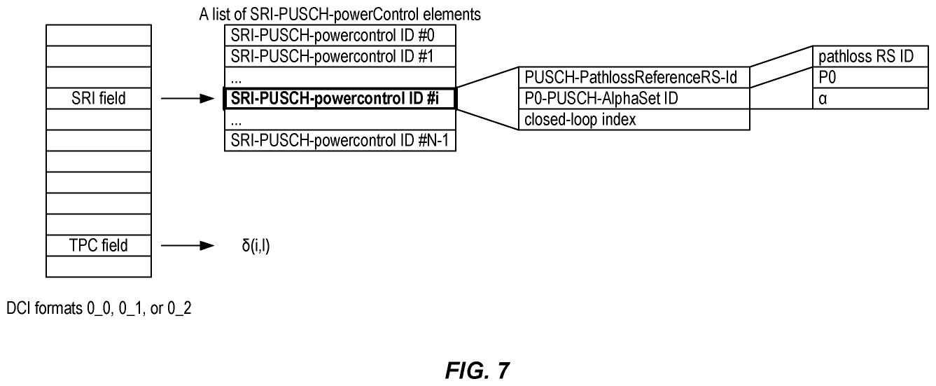

FIG. 7 illustrates, for dynamically scheduled Physical Uplink Shared Channel (PUSCH), a UE is configured by Radio Resource Control (RRC) with a list of SRI-PUSCH-PowerControl elements among which one is selected by the Sounding Reference Signal (SRS) Resource Indicator (SRI) field in DCI (e.g., DCI formats 0_0, 0_1, 0_2);

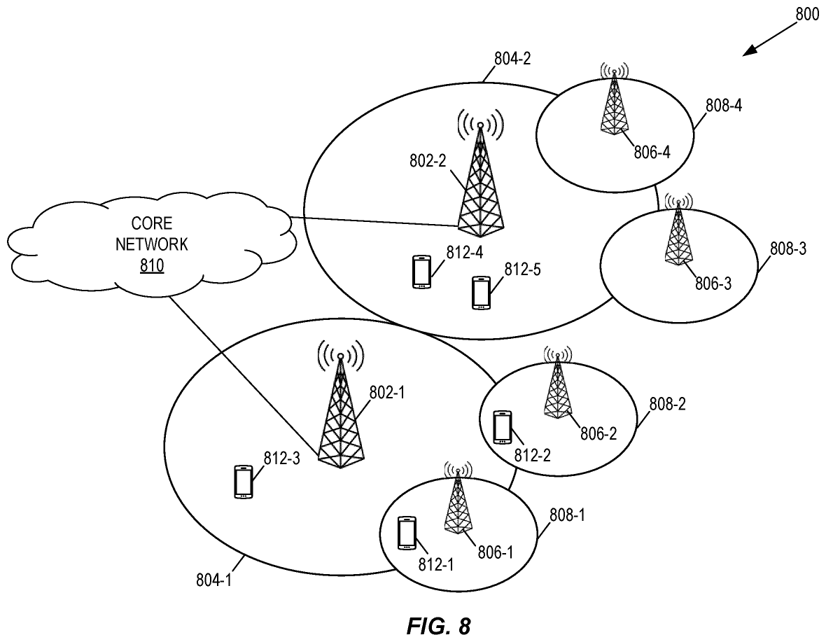

FIG. 8 illustrates one example of a cellular communications system in which embodiments of the present disclosure may be implemented;

FIG. 9 illustrates one example of an embodiment of the present disclosure in which a UE monitors Pathloss Reference Signals (PL-RSs) for N-1 activated uplink (UL) TCI states with lowest TCI field codepoints;

FIG. 10 illustrates one example of an embodiment of the present disclosure in which a UE monitors PL-RSs for the N-1 last activated UL TCI states (in addition to the applied UL TCI state);

FIG. 11 illustrates the operation of a base station (e.g., a gNB) and a wireless communication device (e.g., a UE) in accordance with some embodiments of the present disclosure;

FIG. 12 illustrates the operation of a base station (e.g., a gNB) and a wireless communication device (e.g., a UE) in accordance with some other embodiments of the present disclosure;

FIGS. 13, 14, and 15 are schematic block diagrams of example embodiments of a network node;

FIGS. 16 and 17 are schematic block diagrams of example embodiments of a wireless communication device;

FIG. 18 illustrates an example embodiment of a communication system in which embodiments of the present disclosure may be implemented;

FIG. 19 illustrates example embodiments of the host computer, base station, and UE of FIG. 18; and

FIGS. 20 and 21 are flow charts that illustrate example embodiments of methods implemented in a communication system such as that of FIG. 18.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). In case a UE is not capable of monitoring one Pathloss Reference Signal (PL-RS) for each activated Transmission Configuration Indicator (TCI) state used for uplink (UL) transmit (TX) spatial filter selection (a TCI state used for UL TX spatial filter selection is referred to as “UL TCI state” in the remaining part of the present disclosure, even though it might also be called Joint TCI state/DL TCI state in the 3GPP specification where “Joint TCI state/DL TCI state” means “Joint TCI state or DL TCI state” or “joint or DL TCI state” and can be alternatively be written as “joint/DL TCI state” or “joint or DL TCI state”), the UE might not have a reliable path loss estimate for all the activated UL TCI states. In case the UE does not monitor PL-RS for all activated UL TCI states, the problem of how the UE determines the PL-RS needs to be solved.

Certain aspects of the present disclosure and their embodiments may provide solutions to the aforementioned or other challenges. Systems and methods are disclosed herein for determining which PL-RSs the UE is to monitor in case the UE cannot monitor PL-RS for all activated UL TCI states. Systems and methods are also disclosed herein that define how the UE should behave when it receives an indication to apply an UL TCI state for which it does not monitor a PL-RS.

Certain embodiments may provide one or more of the following technical advantage(s). Embodiments of the present disclosure may enable the UE to have a well-defined framework for how to handle UL output power when the gNB indicates a switch to a new UL TCI state for which the UE is not monitoring a PL-RS. In some embodiments, the framework also indicates to the UE which subset of the activate UL TCI states that the UE should monitor PL-RS for. Both of these aspects will lead to improved UL performance in case there are more activate UL TCI states than monitored PL-RS.

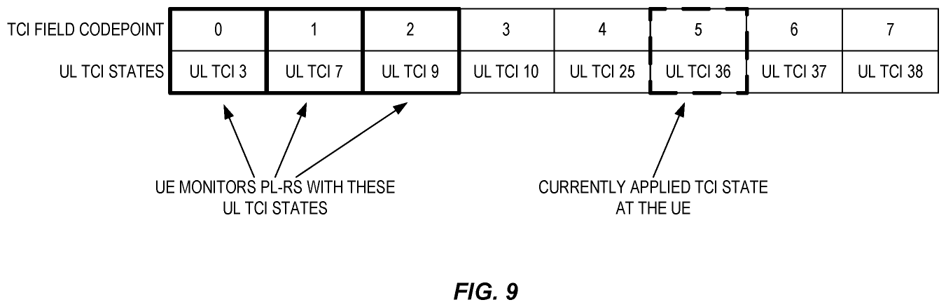

FIG. 8 illustrates one example of a cellular communications system 800 in which embodiments of the present disclosure may be implemented. In the embodiments described herein, the cellular communications system 800 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC); however, the embodiments of the present disclosure are not limited thereto. In this example, the RAN includes base stations 802-1 and 802-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 804-1 and 804-2. The base stations 802-1 and 802-2 are generally referred to herein collectively as base stations 802 and individually as base station 802. Likewise, the (macro) cells 804-1 and 804-2 are generally referred to herein collectively as (macro) cells 804 and individually as (macro) cell 804. The RAN may also include a number of low power nodes 806-1 through 806-4 controlling corresponding small cells 808-1 through 808-4. The low power nodes 806-1 through 806-4 can be small base stations (such as pico or femto base stations) or RRHs, or the like. Notably, while not illustrated, one or more of the small cells 808-1 through 808-4 may alternatively be provided by the base stations 802. The low power nodes 806-1 through 806-4 are generally referred to herein collectively as low power nodes 806 and individually as low power node 806. Likewise, the small cells 808-1 through 808-4 are generally referred to herein collectively as small cells 808 and individually as small cell 808. The cellular communications system 800 also includes a core network 810, which in the 5G System (5GS) is referred to as the 5GC. The base stations 802 (and optionally the low power nodes 806) are connected to the core network 810. The base stations 802 and the low power nodes 806 provide service to wireless communication devices 812-1 through 812-5 in the corresponding cells 804 and 808. The wireless communication devices 812-1 through 812-5 are generally referred to herein collectively as wireless communication devices 812 and individually as wireless communication device 812. In the following description, the wireless communication devices 812 are oftentimes UEs and as such sometimes referred to herein as UEs 812, but the present disclosure is not limited thereto.

Now, a description of some example embodiments of the present disclosure will be provided. While separate headings are used, the embodiments described below may be used in any desired combination unless otherwise stated or required.

### Embodiments Related to Determining a Subset of Activated UL TCI States for Which the UE Should Monitor PL-RS

Assume that the UE 812 can monitor PL-RSs for only N of M activated UL TCI states, where N<M. In one example embodiment, N is equal to, e.g., 4 and M is equal to, e.g., 8. Each of the M activated UL TCI states may be associated with a different PL-RS. Note that, in current 3GPP standards, the maximum number of PL-RSS that a UE can monitor is defined per serving cell. Currently, a UE can monitor a maximum of four PL-RSs per serving cell. So, in case carrier aggregation is used with multiple serving cells, the number of PL-RSs that a UE can monitor in total across the multiple serving cells is N times number of serving cells.

In one embodiment, the UE 812 monitors PL-RS associated with N of the M activated UL TCI states, where the N activated UL TCI states for which the UE monitors PL-RS are based on the association between the activated UL TCI states and their TCI field codepoints (i.e., the TCI field codepoint in DCI used to indicate (apply) one of the M activated UL TCI states). Note that as long as more than one UL TCI state is activated (at least for single TRP operation), there is always an association between an activated UL TCI state and a TCI field codepoint.

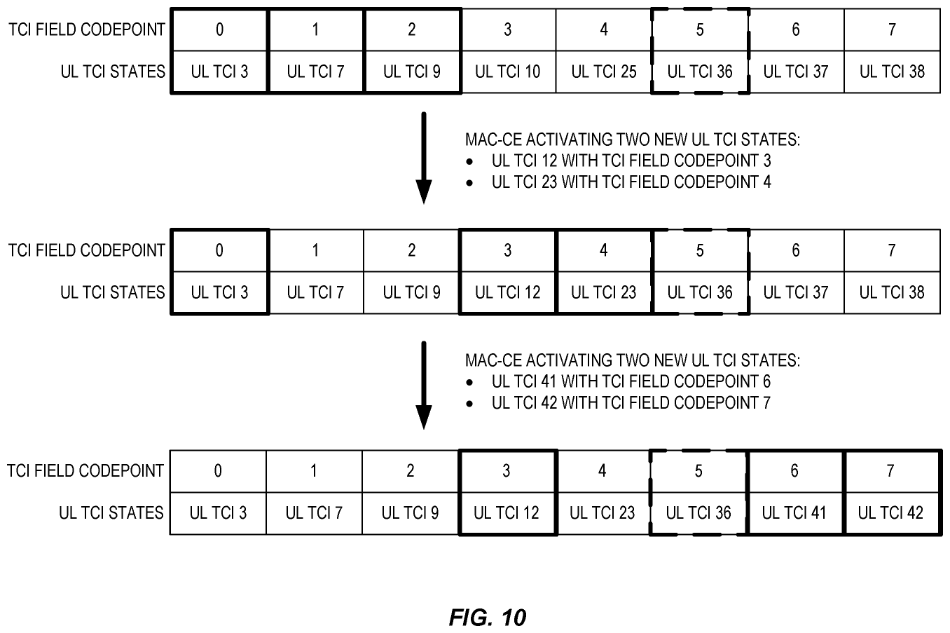

In one variation of this embodiment, the UE 812 monitors PL-RSs for N-1 activated UL TCI states with lowest TCI field codepoints. Note that, in one embodiment, the UE 812 needs to monitor PL-RS for the currently applied UL TCI state; hence N-1 is used instead of N. One example of this embodiment is illustrated in FIG. 9, where UL TCI 36 is currently applied for the UE 812, so the UE 812 monitors PL-RS for this UL TCI state. In addition, the UE 812 monitors UL TCI states with the N-1 (where in this example N=4) lowest TCI field codepoints (i.e., the UL TCI states associate with TCI field codepoints 0, 1, and 2, which in this example are TCI states 3, 7, and 9). In one embodiment, if the currently applied UL TCI state is associated with any of the N lowest TCI field codepoints, the UE 812 monitors the PL-RSS corresponding to the N activated UL TCI states with lowest TCI field codepoints.

In another variation of this embodiment, the UE 812 instead monitors the UL TCI states associated with the N-1 highest TCI field codepoints. In one embodiment, if the currently applied UL TCI state is associated with any of the N highest TCI field codepoints, the UE 812 monitors the PL-RSs corresponding to the N activated UL TCI states with the highest TCI field codepoints.

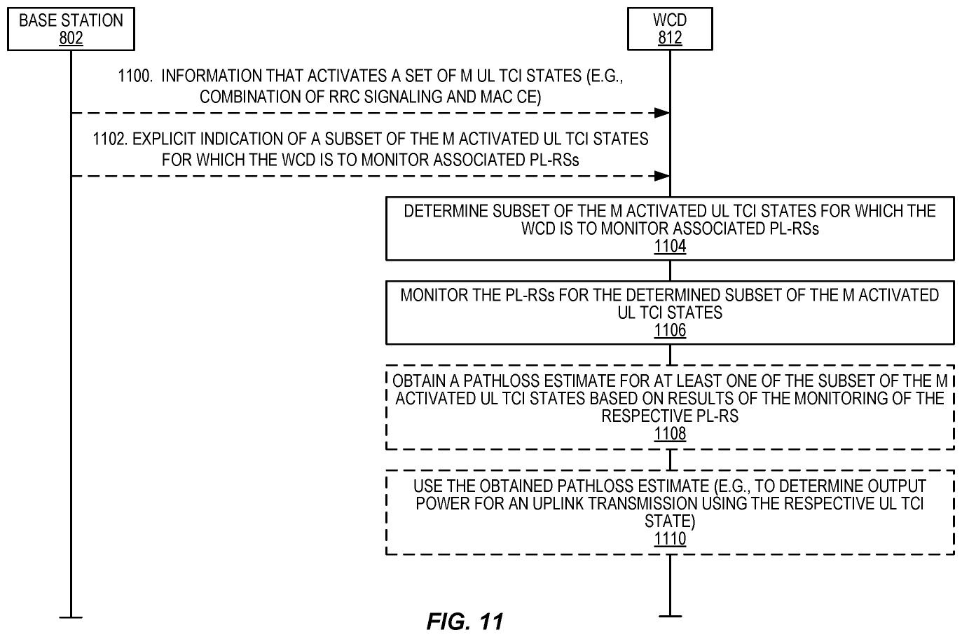

In another embodiment, the UE 812 monitors PL-RSs for the N-1 last activated UL TCI states (in addition to the applied UL TCI state). If the currently applied UL TCI state is associated with any of the N last activated UL TCI states, the UE monitors the PL-RSs corresponding to the N UL TCI states that were most recently activated. One example of this embodiment is illustrated in FIG. 10. In the example of FIG. 10, in the first step, the UE 812 monitors PL-RS for UL TCI 3, 7, and 9. The base station 802 (e.g., gNB) then activates two new UL TCI states with a Medium Access Control (MAC) Control Element (CE), where in this example the two new activated UL TCI states are UL TCI 12 associated with TCI field codepoint 3 and UL TCI 23 associated with TCI field codepoint 4. The N-1 last activated UL TCI states are now UL TCI 3, 12, and 23, so the UE 812 now monitors PL-RS for these UL TCI states. In the next step, a new MAC CE is signaled from the base station 802 (e.g., gNB) to activate two new UL TCI states, which in this example are UL TCI 41 associated with TCI field codepoint 6 and UL TCI 42 associated with TCI field codepoint 8, and the UE 812 starts to monitor PL-RS for these two UL TCI states. Since UL TCI 3 was activated before UL TCI 12 and UL TCI 23, the UE 812 will stop monitoring the PL-RS for UL TCI 3. However, both UL TCI 12 and UL TCI 23 were activated at the same time; hence, an additional rule needs to be specified to indicate which UL TCI state the UE should monitor PL-RS for when multiple UL TCI states were activated at the same time. The same problem will occur in case the base station 802 (e.g., gNB) activates N (or more) UL TCI states in the same MAC-CE. In one embodiment (as is also exemplified in FIG. 10), in case the UE 812 needs to select a subset of simultaneously activated UL TCI states to monitor PL-RS for, the UE 812 selects UL TCI states with lowest TCI field codepoints. So, as shown in FIG. 10, the UE 812 will continue to monitor UL TCI 12 instead of UL TCI 23, since UL TCI 12 is associated with a lower TCI field codepoint (3) than UL TCI 23 (4).

In the above embodiment, the UL TCI states that were most recently activated were prioritized. Note that an activation message can contain an UL TCI state that was already activated. In another embodiment, UL TCI states that are newly activated are prioritized. In other words, the UL TCI states that have been activated for the shortest time are prioritized.

In another embodiment, the UE 812 monitors PL-RSs for the N-1 activated UL TCI states with lowest UL TCI state ID (in addition to the applied UL TCI state). So, for example, in case the UE 812 has UL TCI states 1,2,3,5,6,8 activated, and UL TCI state 7 applied, the UE 812 monitors the PL-RS associated with the N-1 (where N=4 in this example) UL TCI states with lowest UL TCI state ID (i.e., UL TCI 1, UL TCI 2, UL TCI 3, in this example) in addition to the already applied UL TCI state (UL TCI state 7). In one alternate of this embodiment, the UE 812 monitors the PL-RS associated with the UL TCI states with highest UL TCI state ID instead.

In another embodiment, the network (e.g., the base station 802) explicitly signals the N prioritized UL TCI states for which the UE 812 should track the associated PL-RS. The signaling may be made by Radio Resource Control (RRC), MAC CE, Downlink Control Information (DCI), or any combination thereof. For example, the signaling could be included in the TCI state activation message or signaled separately.

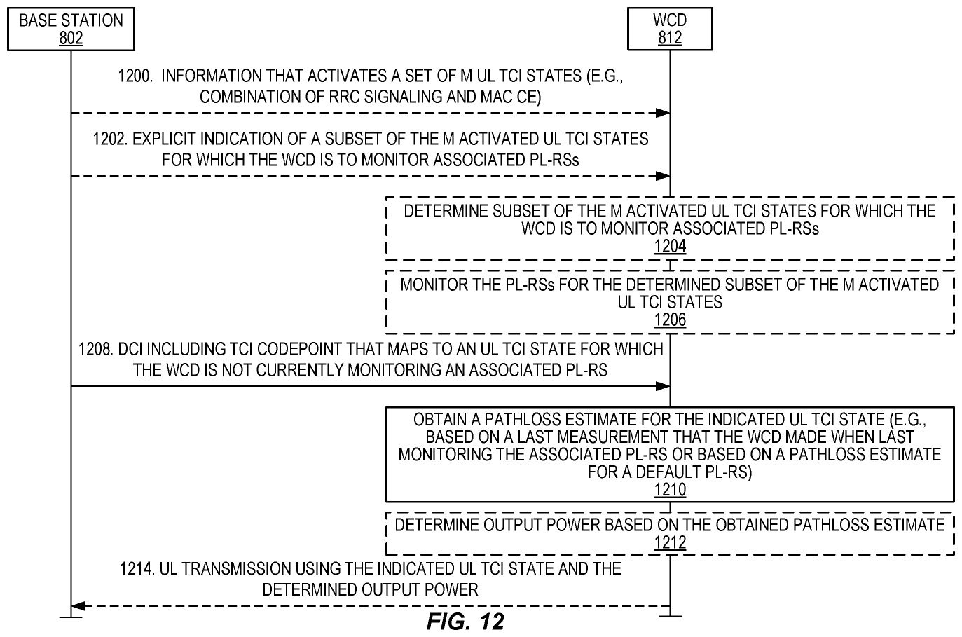

FIG. 11 illustrates the operation of a base station 802 (e.g., a gNB) and a wireless communication device 812 (e.g., a UE) in accordance with at least some of the embodiments above. Optional steps are represented by dashed lines/boxes. As discussed above, the base station 802 signals, to the wireless communication device 812, information activates a set of M UL TCI states for the wireless communication device 812 (step 1100). In one embodiment, this is done via a combination of RRC and MAC CE signaling, e.g., as described in the Introduction section. As described above, in one embodiment, the base station 802 signals, to the wireless communication device 812, information that explicitly indicates a subset of the M activated UL TCI states for which the wireless communication device 812 is to monitor the associated PL-RSs (step 1102).

The wireless communication device 812 determines a subset of the M activated UL TCI states for which the wireless communication device 812 is to monitor the associated PL-RSs (step 1104). In one embodiment, the subset is N out of the M activated UL TCI states, where N<M. In another embodiment, the subset is N-1 out of the M activated UL TCI states, where N<M and the wireless communication device 812 also monitors the PL-RS associated to the current UL TCI state of the wireless communication device 812). In one embodiment, the wireless communication device 812 determines the subset of the M activated UL TCI states for which the wireless communication device 812 is to monitor the associated PL-RSs based on explicit signaling from the base station 802 (e.g., in step 1102). However, in other embodiments, the wireless communication device 812 determines the subset of the M activated UL TCI states for which the wireless communication device 812 is to monitor the associated PL-RSs based on the TCI field codepoints associated to the activated TCI states, in accordance with any of the related embodiments described above. In some other embodiments, the wireless communication device 812 determines the subset of the M activated UL TCI states for which the wireless communication device 812 is to monitor the associated PL-RSs based on the TCI indices of the activated TCI states, in accordance with any of the related embodiments described above. In some other embodiments, the wireless communication device 812 determines the subset of the M activated UL TCI states for which the wireless communication device 812 is to monitor the associated PL-RSs based on when the activated TCI states were activated (e.g., selects the N or N-1 most recently activated TCI states), in accordance with any of the related embodiments described above. Any of the other embodiments described above for how the wireless communication device 812, or UE, determines the subset of the M activated UL TCI states for which the wireless communication device 812 is to monitor the associated PL-RSs can alternatively be used.

The wireless communication device 812 monitors PL-RSs associated to the determined subset of the activated UL TCI states (step 1106). The wireless communication device 812 may obtain a pathloss estimate for at least one of the subset of the M activated UL TCI states based on results (e.g., RSRP measurements) of monitoring the respective PL-RS (step 1108). The wireless communication device 812 may use the obtained pathloss estimate for one or more operational tasks (e.g., for determining an output power for an uplink transmission using that UL TCI state based on the obtained pathloss estimate) (step 1110).

### Embodiment Related to How the UE Should Behave When an Activated UL TCI State is Applied for Which the UE Does Not Monitor Path Loss RS

In case the DCI codepoint indicates an UL TCI state for which the UE 812 does not currently monitor PL-RS, it is non-specified how the UE 812 should determine the UL output power for the new UL TCI state (until enough PL-RS measurements has been performed to attain a filtered path loss (PL) estimate). A number of possible embodiments related to this problem are disclosed below.

In one embodiment, the UE 812 attains the PL estimate based on only the last Reference Signal Received Power (RSRP) measurement for the PL-RS associated with that UL TCI state (and its corresponding TX/RX spatial filter). In this way, the UE 812 only needs to store the last RSRP measurement of the PL-RS associated with each activated UL TCI state (and its corresponding UL TX spatial filter) which would require fewer RSRP measurements and no path loss filtering calculations. In one extension to this embodiment, since a single RSRP measurement could be rather unreliable as PL estimation (due to e.g., fast fading effects), the UE 812 could add an additional X dB in UL output power for the first UL transmissions after the UL TCI state switch to make sure that the UL output power for the new UL TCI state does not create UL coverage issues. For example, assume that the UE calculates a UL output power P_{new} from the power control loop based on the last RSRP measurement associated with the new UL TCI state, then the UE 812 should apply the output power P_{new}+X dB (as long as it is not larger than P_{CMAX}) until more reliable path loss estimations associated with the new UL TCI state has been performed by the UE 812.

In another embodiment, the UE 812 bases the PL estimate for a new UL TCI state (for which the UE 812 does not monitor PL-RS) from a default PL-RS. So, if a new UL TCI state is indicated for which the UE 812 does not currently monitor a PL-RS, the UE 812 instead uses a PL estimate calculated from a default PL-RS to calculate the UL output power that should be used for the new UL TCI state. The default PL-RS may be explicitly or implicitly configured. The default PL-RS can, for example, be a Synchronization Signal Block (SSB) or similar.

When the default PL-RS is implicitly configured, the following alternatives can be applied (Physical Uplink Shared Channel (PUSCH), Sounding Reference Signal (SRS), Physical Uplink Control Channel (PUCCH)).
In one embodiment, the default PL-RS is the reference signal associated with the TCI state of the coreset in which the Physical Downlink Control Channel (PDCCH) scheduling the UL transmission is received.
In one embodiment, the default PL-RS is the PUSCH transmission associated with DCI 0_0.
In one embodiment, the default PL-RS is the PUSCH transmission associated with Msg3.
In one embodiment, the default PL-RS for PUCCH is the semi-persistent PUCCH used for initial transmission.

In another embodiment, the UE 812 bases the PL estimate for a new UL TCI state on the PL-RS associated with the previously used (applied) UL TCI state.

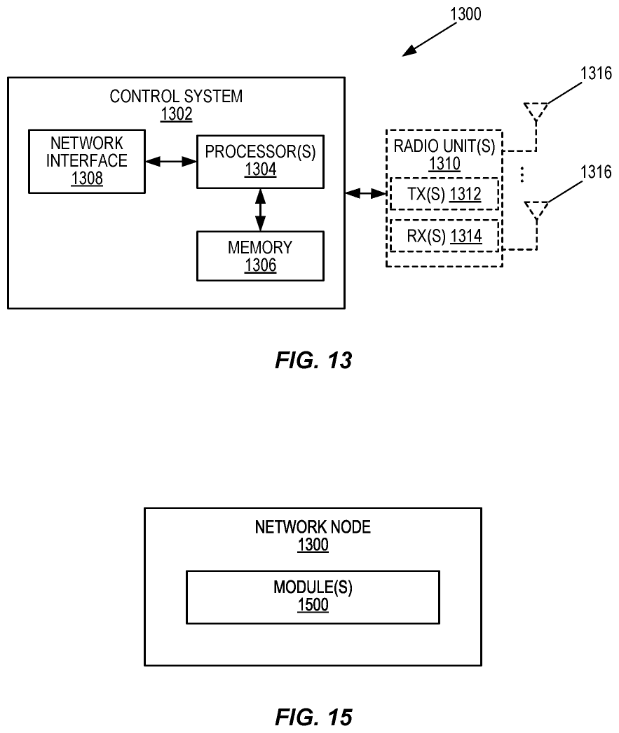

FIG. 12 illustrates the operation of a base station 802 (e.g., a gNB) and a wireless communication device 812 (e.g., a UE) in accordance with at least some of the embodiments above. Optional steps are represented by dashed lines/boxes. As discussed above, the base station 802 signals, to the wireless communication device 812, information activates a set of M UL TCI states for the wireless communication device 812 (step 1200). In one embodiment, this is done via a combination of RRC and MAC CE signaling, e.g., as described in the Introduction section. As described above, in one embodiment, the base station 802 signals, to the wireless communication device 812, information that explicitly indicates a subset of the M activated UL TCI states for which the wireless communication device 812 is to monitor the associated PL-RSs (step 1202). The wireless communication device 812 determines a subset of the M activated UL TCI states for which the wireless communication device 812 is to monitor the associated PL-RSs (step 1204). The details of step 1204 are the same as those for step 1104 provided above and as such are not repeated here.

The wireless communication device 812 monitors PL-RSs associated to the determined subset of the activated UL TCI states (step 1206). The base station 802 sends, and the wireless communication device 812, receives a DCI including a TCI field that is set to a TCI field codepoint that maps to an UL TCI for which the wireless communication device 812 is not currently monitoring the associated PL-RS (step 1208). Responsive to the received DCI, the wireless communication device 812 obtains a pathloss estimate for the indicated UL TCI state even though the wireless communication device 812 is has not been monitoring the associated PL-RS (step 1210). This pathloss estimate may be obtained using any of the related embodiments above. For example, in one embodiment, the wireless communication device 812 obtains a pathloss estimate for the indicated UL TCI state based only on the last RSRP measurement for the PL-RS associated with that UL TCI state (e.g., the last RSRP measurement for that PL-RS made by the wireless communication device 812 when it was last monitoring that PL-RS). As another example, the wireless communication device 812 obtains a pathloss estimate for the indicated UL TCI state based on a pathloss estimate for a default PL-RS. The wireless communication device 812 may then determine an output power for the indicated UL TCI state based on the obtained pathloss estimate (step 1212) and transmit an uplink transmission (e.g., an UL signal or UL channel) using the indicated TCI state and the determined output power (step 1214).

### Further Description

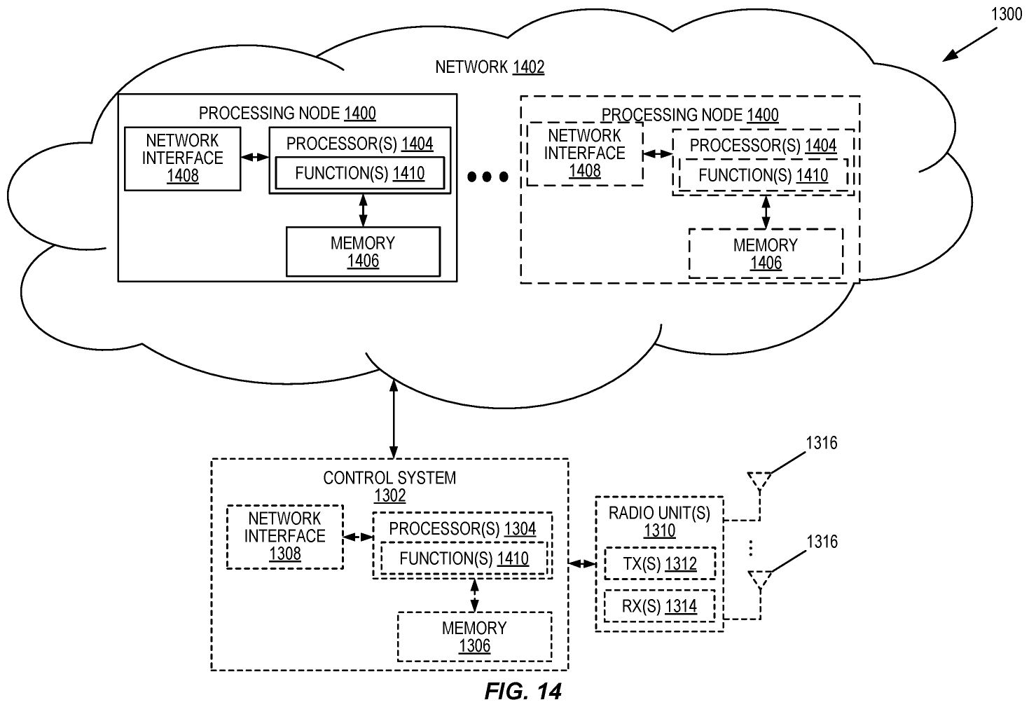

FIG. 13 is a schematic block diagram of a network node 1300 according to some embodiments of the present disclosure. Optional features are represented by dashed boxes. The network node 1300 may be, for example, a base station 802 or 806 or a network node that implements all or part of the functionality of the base station 802 or gNB described herein. As illustrated, the network node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. In addition, if the network node 1300 is a radio access node (e.g., a base station 802, gNB, or network node that implements at least some of the functionality of the base station 802 or gNB), the network node 1300 may include one or more radio units 1310 that each includes one or more transmitters 1312 and one or more receivers 1314 coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of the network node 1300 as described herein (e.g., one or more functions of a base station 802 or gNB described herein). In some embodiments, the function(s) are implemented in software that is stored, e.g., in the memory 1306 and executed by the one or more processors 1304.

FIG. 14 is a schematic block diagram that illustrates a virtualized embodiment of the network node 1300 according to some embodiments of the present disclosure. Again, optional features are represented by dashed boxes. As used herein, a “virtualized” network node is an implementation of the network node 1300 in which at least a portion of the functionality of the network node 1300 is implemented as a virtual component(s) (e.g., via a virtual machine(s) executing on a physical processing node(s) in a network(s)). As illustrated, in this example, if the network node 1300 is a radio access node, the network node 1300 may include the control system 1302 and/or the one or more radio units 1310, as described above. The control system 1302 may be connected to the radio unit(s) 1310 via, for example, an optical cable or the like. The network node 1300 includes one or more processing nodes 1400 coupled to or included as part of a network(s) 1402. If present, the control system 1302 or the radio unit(s) are connected to the processing node(s) 1400 via the network 1402. Each processing node 1400 includes one or more processors 1404 (e.g., CPUs, ASICs, FPGAS, and/or the like), memory 1406, and a network interface 1408.

In this example, functions 1410 of the network node 1300 described herein (e.g., one or more functions of a base station 802 or gNB described herein) are implemented at the one or more processing nodes 1400 or distributed across the one or more processing nodes 1400 and the control system 1302 and/or the radio unit(s) 1310 in any desired manner. In some particular embodiments, some or all of the functions 1410 of the network node 1300 described herein are implemented as virtual components executed by one or more virtual machines implemented in a virtual environment(s) hosted by the processing node(s) 1400. As will be appreciated by one of ordinary skill in the art, additional signaling or communication between the processing node(s) 1400 and the control system 1302 is used in order to carry out at least some of the desired functions 1410. Notably, in some embodiments, the control system 1302 may not be included, in which case the radio unit(s) 1310 communicate directly with the processing node(s) 1400 via an appropriate network interface(s).

In some embodiments, a computer program including instructions which, when executed by at least one processor, causes the at least one processor to carry out the functionality of the network node 1300 or a node (e.g., a processing node 1400) implementing one or more of the functions 1410 of the network node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the network node 1300 according to some other embodiments of the present disclosure. The network node 1300 includes one or more modules 1500, each of which is implemented in software. The module(s) 1500 provide the functionality of the network node 1300 described herein. This discussion is equally applicable to the processing node 1400 of FIG. 14 where the modules 1500 may be implemented at one of the processing nodes 1400 or distributed across multiple processing nodes 1400 and/or distributed across the processing node(s) 1400 and the control system 1302.

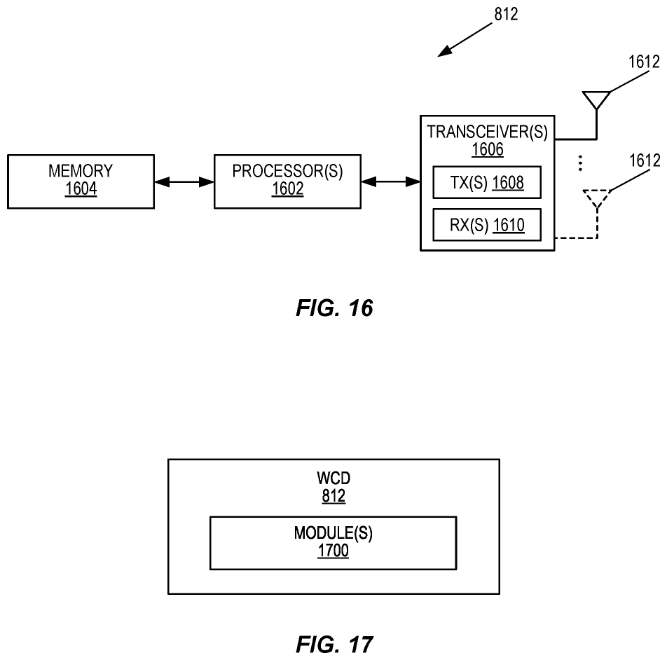

FIG. 16 is a schematic block diagram of a wireless communication device 812 (e.g., a UE) according to some embodiments of the present disclosure. As illustrated, the wireless communication device 812 includes one or more processors 1602 (e.g., CPUs, ASICS, FPGAS, and/or the like), memory 1604, and one or more transceivers 1606 each including one or more transmitters 1608 and one or more receivers 1610 coupled to one or more antennas 1612. The transceiver(s) 1606 includes radio-front end circuitry connected to the antenna(s) 1612 that is configured to condition signals communicated between the antenna(s) 1612 and the processor(s) 1602, as will be appreciated by on of ordinary skill in the art. The processors 1602 are also referred to herein as processing circuitry. The transceivers 1606 are also referred to herein as radio circuitry. In some embodiments, the functionality of the wireless communication device 812 (or UE) described above may be fully or partially implemented in software that is, e.g., stored in the memory 1604 and executed by the processor(s) 1602. Note that the wireless communication device 812 may include additional components not illustrated in FIG. 16 such as, e.g., one or more user interface components (e.g., an input/output interface including a display, buttons, a touch screen, a microphone, a speaker(s), and/or the like and/or any other components for allowing input of information into the wireless communication device 812 and/or allowing output of information from the wireless communication device 812), a power supply (e.g., a battery and associated power circuitry), etc.

In some embodiments, a computer program including instructions which, when executed by at least one processor, causes the at least one processor to carry out the functionality of the wireless communication device 812 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 17 is a schematic block diagram of the wireless communication device 812 according to some other embodiments of the present disclosure. The wireless communication device 812 includes one or more modules 1700, each of which is implemented in software. The module(s) 1700 provide the functionality of the wireless communication device 812 (or UE) described herein.

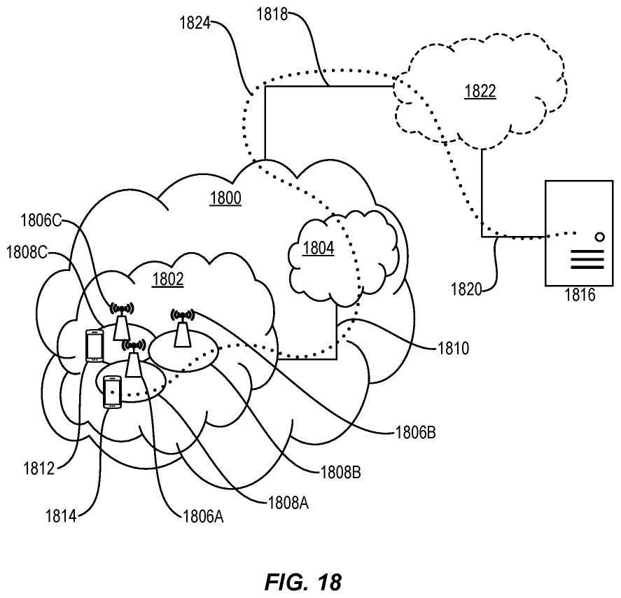

With reference to FIG. 18, in accordance with an embodiment, a communication system includes a telecommunication network 1800, such as a 3GPP-type cellular network, which comprises an access network 1802, such as a RAN, and a core network 1804. The access network 1802 comprises a plurality of base stations 1806A, 1806B, 1806C, such as Node Bs, eNBs, gNBs, or other types of wireless Access Points (APs), each defining a corresponding coverage area 1808A, 1808B, 1808C. Each base station 1806A, 1806B, 1806C is connectable to the core network 1804 over a wired or wireless connection 1810. A first UE 1812 located in coverage area 1808C is configured to wirelessly connect to, or be paged by, the corresponding base station 1806C. A second UE 1814 in coverage area 1808A is wirelessly connectable to the corresponding base station 1806A. While a plurality of UEs 1812, 1814 are illustrated in this example, the disclosed embodiments are equally applicable to a situation where a sole UE is in the coverage area or where a sole UE is connecting to the corresponding base station 1806.

The telecommunication network 1800 is itself connected to a host computer 1816, which may be embodied in the hardware and/or software of a standalone server, a cloud-implemented server, a distributed server, or as processing resources in a server farm. The host computer 1816 may be under the ownership or control of a service provider, or may be operated by the service provider or on behalf of the service provider. Connections 1818 and 1820 between the telecommunication network 1800 and the host computer 1816 may extend directly from the core network 1804 to the host computer 1816 or may go via an optional intermediate network 1822. The intermediate network 1822 may be one of, or a combination of more than one of, a public, private, or hosted network; the intermediate network 1822, if any, may be a backbone network or the Internet; in particular, the intermediate network 1822 may comprise two or more sub-networks (not shown).

The communication system of FIG. 18 as a whole enables connectivity between the connected UEs 1812, 1814 and the host computer 1816. The connectivity may be described as an Over-the-Top (OTT) connection 1824. The host computer 1816 and the connected UEs 1812, 1814 are configured to communicate data and/or signaling via the OTT connection 1824, using the access network 1802, the core network 1804, any intermediate network 1822, and possible further infrastructure (not shown) as intermediaries. The OTT connection 1824 may be transparent in the sense that the participating communication devices through which the OTT connection 1824 passes are unaware of routing of uplink and downlink communications. For example, the base station 1806 may not or need not be informed about the past routing of an incoming downlink communication with data originating from the host computer 1816 to be forwarded (e.g., handed over) to a connected UE 1812. Similarly, the base station 1806 need not be aware of the future routing of an outgoing uplink communication originating from the UE 1812 towards the host computer 1816.

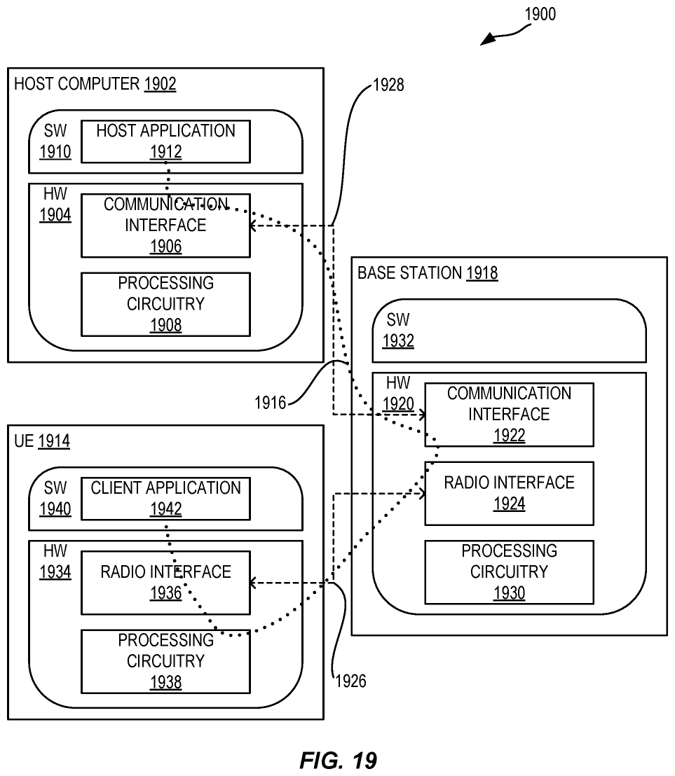

Example implementations, in accordance with an embodiment, of the UE, base station, and host computer discussed in the preceding paragraphs will now be described with reference to FIG. 19. In a communication system 1900, a host computer 1902 comprises hardware 1904 including a communication interface 1906 configured to set up and maintain a wired or wireless connection with an interface of a different communication device of the communication system 1900. The host computer 1902 further comprises processing circuitry 1908, which may have storage and/or processing capabilities. In particular, the processing circuitry 1908 may comprise one or more programmable processors, ASICs, FPGAs, or combinations of these (not shown) adapted to execute instructions. The host computer 1902 further comprises software 1910, which is stored in or accessible by the host computer 1902 and executable by the processing circuitry 1908. The software 1910 includes a host application 1912. The host application 1912 may be operable to provide a service to a remote user, such as a UE 1914 connecting via an OTT connection 1916 terminating at the UE 1914 and the host computer 1902. In providing the service to the remote user, the host application 1912 may provide user data which is transmitted using the OTT connection 1916.

The communication system 1900 further includes a base station 1918 provided in a telecommunication system and comprising hardware 1920 enabling it to communicate with the host computer 1902 and with the UE 1914. The hardware 1920 may include a communication interface 1922 for setting up and maintaining a wired or wireless connection with an interface of a different communication device of the communication system 1900, as well as a radio interface 1924 for setting up and maintaining at least a wireless connection 1926 with the UE 1914 located in a coverage area (not shown in FIG. 19) served by the base station 1918. The communication interface 1922 may be configured to facilitate a connection 1928 to the host computer 1902. The connection 1928 may be direct or it may pass through a core network (not shown in FIG. 19) of the telecommunication system and/or through one or more intermediate networks outside the telecommunication system. In the embodiment shown, the hardware 1920 of the base station 1918 further includes processing circuitry 1930, which may comprise one or more programmable processors, ASICs, FPGAS, or combinations of these (not shown) adapted to execute instructions. The base station 1918 further has software 1932 stored internally or accessible via an external connection.

The communication system 1900 further includes the UE 1914 already referred to. The UE's 1914 hardware 1934 may include a radio interface 1936 configured to set up and maintain a wireless connection 1926 with a base station serving a coverage area in which the UE 1914 is currently located. The hardware 1934 of the UE 1914 further includes processing circuitry 1938, which may comprise one or more programmable processors, ASICS, FPGAS, or combinations of these (not shown) adapted to execute instructions. The UE 1914 further comprises software 1940, which is stored in or accessible by the UE 1914 and executable by the processing circuitry 1938. The software 1940 includes a client application 1942. The client application 1942 may be operable to provide a service to a human or non-human user via the UE 1914, with the support of the host computer 1902. In the host computer 1902, the executing host application 1912 may communicate with the executing client application 1942 via the OTT connection 1916 terminating at the UE 1914 and the host computer 1902. In providing the service to the user, the client application 1942 may receive request data from the host application 1912 and provide user data in response to the request data. The OTT connection 1916 may transfer both the request data and the user data. The client application 1942 may interact with the user to generate the user data that it provides.

It is noted that the host computer 1902, the base station 1918, and the UE 1914 illustrated in FIG. 19 may be similar or identical to the host computer 1816, one of the base stations 1806A, 1806B, 1806C, and one of the UEs 1812, 1814 of FIG. 18, respectively. This is to say, the inner workings of these entities may be as shown in FIG. 19 and independently, the surrounding network topology may be that of FIG. 18.

In FIG. 19, the OTT connection 1916 has been drawn abstractly to illustrate the communication between the host computer 1902 and the UE 1914 via the base station 1918 without explicit reference to any intermediary devices and the precise routing of messages via these devices. The network infrastructure may determine the routing, which may be configured to hide from the UE 1914 or from the service provider operating the host computer 1902, or both. While the OTT connection 1916 is active, the network infrastructure may further take decisions by which it dynamically changes the routing (e.g., on the basis of load balancing consideration or reconfiguration of the network).

The wireless connection 1926 between the UE 1914 and the base station 1918 is in accordance with the teachings of the embodiments described throughout this disclosure. One or more of the various embodiments improve the performance of OTT services provided to the UE 1914 using the OTT connection 1916, in which the wireless connection 1926 forms the last segment.

A measurement procedure may be provided for the purpose of monitoring data rate, latency, and other factors on which the one or more embodiments improve. There may further be an optional network functionality for reconfiguring the OTT connection 1916 between the host computer 1902 and the UE 1914, in response to variations in the measurement results. The measurement procedure and/or the network functionality for reconfiguring the OTT connection 1916 may be implemented in the software 1910 and the hardware 1904 of the host computer 1902 or in the software 1940 and the hardware 1934 of the UE 1914, or both. In some embodiments, sensors (not shown) may be deployed in or in association with communication devices through which the OTT connection 1916 passes; the sensors may participate in the measurement procedure by supplying values of the monitored quantities exemplified above, or supplying values of other physical quantities from which the software 1910, 1940 may compute or estimate the monitored quantities. The reconfiguring of the OTT connection 1916 may include message format, retransmission settings, preferred routing, etc.; the reconfiguring need not affect the base station 1918, and it may be unknown or imperceptible to the base station 1918. Such procedures and functionalities may be known and practiced in the art. In certain embodiments, measurements may involve proprietary UE signaling facilitating the host computer 1902's measurements of throughput, propagation times, latency, and the like. The measurements may be implemented in that the software 1910 and 1940 causes messages to be transmitted, in particular empty or ‘dummy’ messages, using the OTT connection 1916 while it monitors propagation times, errors, etc.

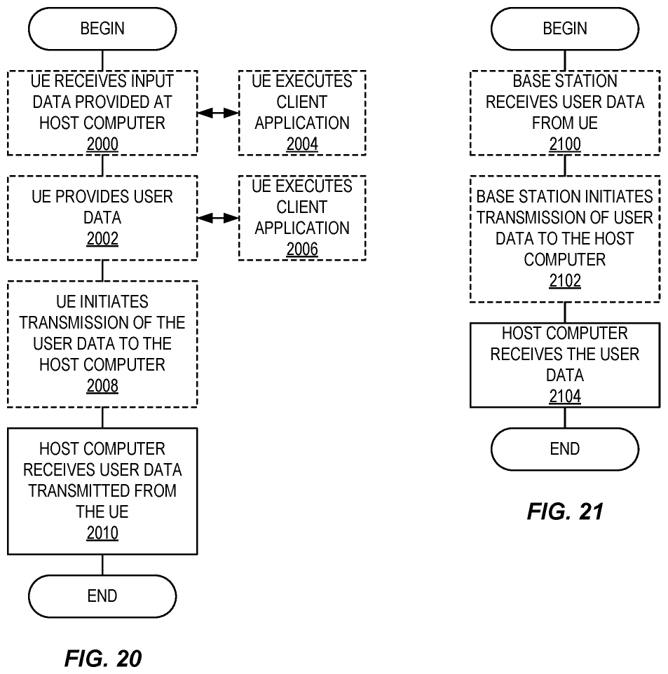

FIG. 20 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 20 will be included in this section. In step 2000 (which may be optional), the UE receives input data provided by the host computer. Additionally or alternatively, in step 2002, the UE provides user data. In sub-step 2004 (which may be optional) of step 2000, the UE provides the user data by executing a client application. In sub-step 2006 (which may be optional) of step 2002, the UE executes a client application which provides the user data in reaction to the received input data provided by the host computer. In providing the user data, the executed client application may further consider user input received from the user. Regardless of the specific manner in which the user data was provided, the UE initiates, in sub-step 2008 (which may be optional), transmission of the user data to the host computer. In step 2010 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 21 will be included in this section. In step 2100 (which may be optional), in accordance with the teachings of the embodiments described throughout this disclosure, the base station receives user data from the UE. In step 2102 (which may be optional), the base station initiates transmission of the received user data to the host computer. In step 2104 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a wireless communication device, the method comprising:
determining a subset of a set of activated uplink, UL, transmission configuration indicator, TCI, states or activated joint or downlink, DL, TCI states for the wireless communication device for which the wireless communication device is to monitor associated pathloss reference signals; and
monitoring the pathloss reference signals for the subset of the set of activated UL TCI states or activated joint or DL TCI states.

2. (canceled)

3. (canceled)

4. The method of claim 1 wherein the set of activated UL TCI states or activated joint or DL TCI states consists of M activated UL TCI states or M activated joint or DL TCI states, and the subset of the set of activated UL TCI states or activated joint or DL TCI states consists of less than M activated UL TCI states or less than M activated joint or DL TCI states.

5. The method of claim 4 wherein determining the subset of the set of activated UL TCI states or activated joint or DL TCI states for which the wireless communication device is to monitor associated pathloss reference signals comprises selecting the subset from the set of activated UL TCI states or activated joint or DL TCI states based on associations between the activated UL TCI states or activated joint or DL TCI states and their TCI field codepoints.

6. The method of claim 5 wherein the subset is either N or N-1 of the M activated UL TCI states or either N or N-1 of the M activated joint or DL TCI states having the highest or lowest TCI field codepoints, where a value of N corresponds to a maximum number of pathloss reference signals that the wireless communication device is configured or otherwise able to monitor.

7-13. (canceled)

14. The method of claim 4 wherein the subset is either N or N-1 of the M activated UL TCI states or either N or N-1 of the M activated joint or DL TCI states that were last activated, where a value of N corresponds to a maximum number of pathloss reference signals that the wireless communication device is configured or otherwise able to monitor.

15-19. (canceled)

20. The method of claim 4 wherein the subset is either N or N-1 of the M activated UL TCI states or either N or N-1 of the M activated joint or DL TCI states that have been activated for a shortest amount of time, where a value of N corresponds to a maximum number of pathloss reference signals that the wireless communication device is configured or otherwise able to monitor.

21-23. (canceled)

24. The method of claim 4 wherein the subset is either N or N-1 of the M activated UL TCI states or either N or N-1 of the M activated joint or DL TCI states having the highest or lowest TCI state IDs, where a value of N corresponds to a maximum number of pathloss reference signals that the wireless communication device is configured or otherwise able to monitor.

25-31. (canceled)

32. The method of claim 4 further comprising:
receiving, from a network node, an indication of the subset of the set of activated UL TCI states or activated joint or DL TCI states for which the wireless communication device is to monitor associated pathloss reference signals;
wherein determining the subset of the set of activated UL TCI states or activated joint or DL TCI states for which the wireless communication device is to monitor associated pathloss reference signals comprises determining the subset from the set of activated UL TCI states or activated joint or DL TCI states based on the received indication.

33-36. (canceled)

37. The method of claim 1 further comprising:
receiving downlink control information, DCI, from a network node, the DCI comprising a TCI field codepoint that maps to an activated UL TCI state or an activated joint or DL TCI state from among the set of activated UL TCI states or activated joint or DL TCI states for which the wireless communication device is not currently monitoring an associated pathloss reference signal; and
responsive thereto, obtaining a pathloss estimate for the activated UL TCI state or the activated joint or DL TCI state indicated by the TCI field codepoint comprised in the DCI.

38-44. (canceled)

45. A wireless communication device comprising:
one or more transmitters;
one or more receivers; and
processing circuitry associated with the one or more transmitters and the one or more receivers, the processing circuitry configured to cause the wireless communication device to:
determine a subset of a set of activated uplink, UL, or joint/downlink, DL, transmission configuration indicator, TCI, states for the wireless communication device for which the wireless communication device is to monitor associated pathloss reference signals; and
monitor the pathloss reference signals for the subset of the set of activated UL or joint/downlink DL TCI states.

46. (canceled)

47. A method performed by a network node, the method comprising:
transmitting, to a wireless communication device, an indication of a subset of a set of activated uplink, UL, transmission configuration indicator, TCI, states or activated joint or downlink, DL, TCI states for the wireless communication device for which the wireless communication device is to monitor associated pathloss reference signals.

48. (canceled)

49. A network node for an access network of a cellular communications system, the network node comprising processing circuitry configured to cause the network node to:
transmit, to a wireless communication device, an indication of a subset of a set of activated uplink, UL, transmission configuration indicator, TCI, states or activated joint or downlink, DL, TCI states for the wireless communication device for which the wireless communication device is to monitor associated pathloss reference signals.

50. The wireless communication device of claim 45, wherein the set of activated UL TCI states or activated joint or DL TCI states consists of M activated UL TCI states or M activated joint or DL TCI states, and the subset of the set of activated UL TCI states or activated joint or DL TCI states consists of less than M activated UL TCI states or less than M activated joint or DL TCI states.

51. The wireless communication device of claim 50, wherein in order to determine the subset of the set of activated UL TCI states or activated joint or DL TCI states for which the wireless communication device is to monitor associated pathloss reference signals, the processing circuitry is further configured to cause the wireless communication device to select the subset from the set of activated UL TCI states or activated joint or DL TCI states based on associations between the activated UL TCI states or activated joint or DL TCI states and their TCI field codepoints.

52. The wireless communication device of claim 51, wherein the subset is either N or N-1 of the M activated UL TCI states or either N or N-1 of the M activated joint or DL TCI states having the highest or lowest TCI field codepoints, where a value of N corresponds to a maximum number of pathloss reference signals that the wireless communication device is configured or otherwise able to monitor.

53. The wireless communication device of claim 50, wherein the subset is either N or N-1 of the M activated UL TCI states or either N or N-1 of the M activated joint or DL TCI states that were last activated, where a value of N corresponds to a maximum number of pathloss reference signals that the wireless communication device is configured or otherwise able to monitor.

54. The wireless communication device of claim 50, wherein the subset is either N or N-1 of the M activated UL TCI states or either N or N-1 of the M activated joint or DL TCI states that have been activated for a shortest amount of time, where a value of N corresponds to a maximum number of pathloss reference signals that the wireless communication device is configured or otherwise able to monitor.

55. The wireless communication device of claim 50, wherein the subset is either N or N-1 of the M activated UL TCI states or either N or N-1 of the M activated joint or DL TCI states having the highest or lowest TCI state IDs, where a value of N corresponds to a maximum number of pathloss reference signals that the wireless communication device is configured or otherwise able to monitor.

56. The method of claim 50, wherein the processing circuitry is further configured to cause the wireless communication device to:
receive, from a network node, an indication of the subset of the set of activated UL TCI states or activated joint or DL TCI states for which the wireless communication device is to monitor associated pathloss reference signals;
wherein, in order to determine the subset of the set of activated UL TCI states or activated joint or DL TCI states for which the wireless communication device is to monitor associated pathloss reference signals, the processing circuitry is further configured to cause the wireless communication device to determine the subset from the set of activated UL TCI states or activated joint or DL TCI states based on the received indication.
